(19) United States
(12) Patent Application Publication
(10) Pub. No.: US 2013/0064306 A1
(43) Pub. Date: Mar. 14, 2013

(54) Variable Link Rate Streaming For Audio And Video Content From Home Media Server

(71) Applicants: Rajesh Mamidwar, San Diego, CA (US); Sanjeev Sood, San Diego, CA (US)

(72) Inventors: Rajesh Mamidwar, San Diego, CA (US); Sanjeev Sood, San Diego, CA (US)

(73) Assignee: Broadcom Corporation, Irvine, CA (US)

(21) Appl. No.: 13/248,909

(22) Filed: Sep. 29, 2011

Related U.S. Application Data
(60) Provisional application No. 61/486,498, filed on May 16, 2011.

(51) Int. Cl. H04N 7/26

(52) U.S. Cl. 375/240.26; 375/E07.016

(57) ABSTRACT

An encoder arrangement is provided for streaming media. A variable rate encoder is configured and arranged to receive an input data stream and output an encoded data stream. A buffer is arranged to receive the encoded data stream and output a buffered data stream. A control means monitors depth of the buffer and controls the encoding rate of the variable rate encoder so that encoding is carried out at a rate appropriate to an available link rate, thereby providing smooth transition of data stream quality as link conditions change.

### BACKGROUND

1. Field of Invention

The invention relates in general to audio and video data streaming.

2. Related Art

With the proliferation of portable media playing devices (PDAs, smart phones, tablets, small computers, etc.) and wireless (WiFi, Bluetooth, etc.) and wired links (multi-media over coax (MoCA), Powerline communications including power line carrier (PLC), power line telecom (PLT), power line networking (PLN) and broadband over power line (BPL), Ethernet, etc.), streaming media (video and audio) from home servers and other sources is becoming more popular. Cable, satellite and other media service providers seek ways to provide audio/video content from home media servers, such as, for example, digital video recorder (DVR) boxes and the like to these portable devices. Also, providers are looking for ways to utilize a single media server, such as for example, a DVR box, to stream media to multiple devices within a home, such as auxiliary set top boxes, etc. With the proliferation of devices and links, a problem has become evident. As a user moves within a house or between inside and outside of a house there may be a variation in link speed (bandwidth) over which the media is being streamed. A portable device may not be able to keep up with a faster encoded data stream being sent by a home media server. On the other hand, if a streaming configuration is set for a “lowest common denominator” (slowest possible encoding rate suitable for worst possible link condition) a device capable of greater bandwidth transfer will not receive optimum signal quality available by faster encoding.

### BRIEF DESCRIPTION OF DRAWINGS

The accompanying drawings, which are incorporated herein and form a part of the specification, illustrate the present invention and, together with the description, further serve to explain the principles of the invention and to enable a person skilled in the pertinent art to make and use the invention. In the drawings, like reference numbers may indicate identical or functionally similar elements. The drawing in which an element first appears is generally indicated by the left-most digit in the corresponding reference number. The accompanying drawings, which are incorporated in and constitute part of the specification, illustrate embodiments of the invention and, together with the general description given above and the detailed descriptions of embodiments given below, serve to explain the principles of the present invention.

FIG. 1 is a schematic diagram of a streaming arrangement including a video encoder having a controllable encoding rate according to an embodiment of the invention.

FIG. 2 is a schematic diagram of a streaming arrangement including a video encoder according to an embodiment of the invention in which plural encoders having different encoding rates are selectable.

FIG. 3 is a schematic diagram of a streaming arrangement including a video encoder according to an embodiment of the invention in which the encoding rate of an encoder is determined based on a link rate of streaming data.

FIG. 4 is a schematic diagram of a streaming arrangement including a video encoder according to an embodiment of the invention in which the encoding rate of an encoder is determined based on a link rate of streaming data.

Features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF EMBODIMENTS

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

It should be understood that spatial descriptions (e.g., “above”, “below”, “left,” “right,” “up”, “down”, “top”, “bottom”, etc.) used herein are for purposes of illustration only, and that practical implementations of the structures described herein can be spatially arranged in any orientation or manner.

The invention will be better understood from the following descriptions of various embodiments of the invention. Thus, specific embodiments are views of the invention, but each does not itself represent the whole invention. In many cases individual elements from one particular embodiment may be substituted for different elements in another embodiment carrying out a similar or corresponding function. The present invention relates to streaming data from a media server.

Consistent with the principles of the present invention as embodied and broadly described herein, the invention is generally directed to solving the problem of varying link rates available in streaming to devices at different locations within an environment, such as for example, a home; or the problem of streaming to a portable device that is moved from one location to another within an environment and wherein that movement results in a change in available link speed. For example, a user moving within a house or between inside and outside of a house while streaming media from a home media server to a portable device may encounter changes in available link rate (bandwidth). In fact, the available link rate may have a wide variation. Embodiments of the invention described in detail below describe arrangements to adapt Audio/Video bit rates as per supported link rate and change audio/video quality gracefully.

According to one embodiment of the invention, there is provided an encoder arrangement for streaming media. A variable rate encoder is configured and arranged to receive an input data stream and output an encoded data stream. A buffer is arranged to receive the encoded data stream and output a buffered data stream. A control means is provided for monitoring a depth of the buffer and controlling the encoding rate of the variable rate encoder.

According to another embodiment of the invention, there is provided an encoder arrangement for streaming media. A plurality of encoders, each having a different encoding rate, are each configured and arranged to receive an input data stream and output an encoded data stream. A buffer is arranged to receive the encoded data stream from any of the encoders and output a buffered data stream. A control means for monitoring a depth of the buffer and controlling which of the plural buffers will actively encode the input data stream and provided an encoded data stream to the buffer.

According to another embodiment of the invention, there is provided an encoder arrangement for streaming media. A variable rate encoder is configured and arranged to receive an input data stream and output an encoded data stream. A buffer arranged to receive the encoded data stream and output a buffered data stream. A control means for monitoring a link speed of the streaming media and controlling the encoding rate of the variable rate encoder.

According to another embodiment of the invention, there is provided an encoder arrangement for streaming media. A plurality of encoders, each having a different encoding rate, are configured and arranged to receive an input data stream and output an encoded data stream. A buffer arranged to receive the encoded data stream from any of the encoders and output a buffered data stream. A control means for monitoring a link speed of the streaming media and controlling which of the plural buffers will actively encode the input data stream and provided an encoded data stream to the buffer.

According to another embodiment of the invention, there is provided an encoder arrangement for streaming media wherein the link speed is determined by a client receiving the streaming media.

According to another embodiment, there is provided an encoder arrangement for streaming media. A plurality of encoders, each having a different encoding rate, are configured and arranged to receive an input data stream and output an encoded data stream, thereby producing plural data streams, each having a different encoding rate. A control means for monitoring a link speed depth of the buffer and selecting an encoded data stream based on the link speed.

Several embodiments of the invention are described below with reference to drawings which are part of this patent document.

Media servers supporting mobile clients can have full transcode function. For example, they can decode an audio/video stream, re-encode (or re-compress) that audio/video stream and send it to network connected devices, such as tablets, set top boxes, etc.

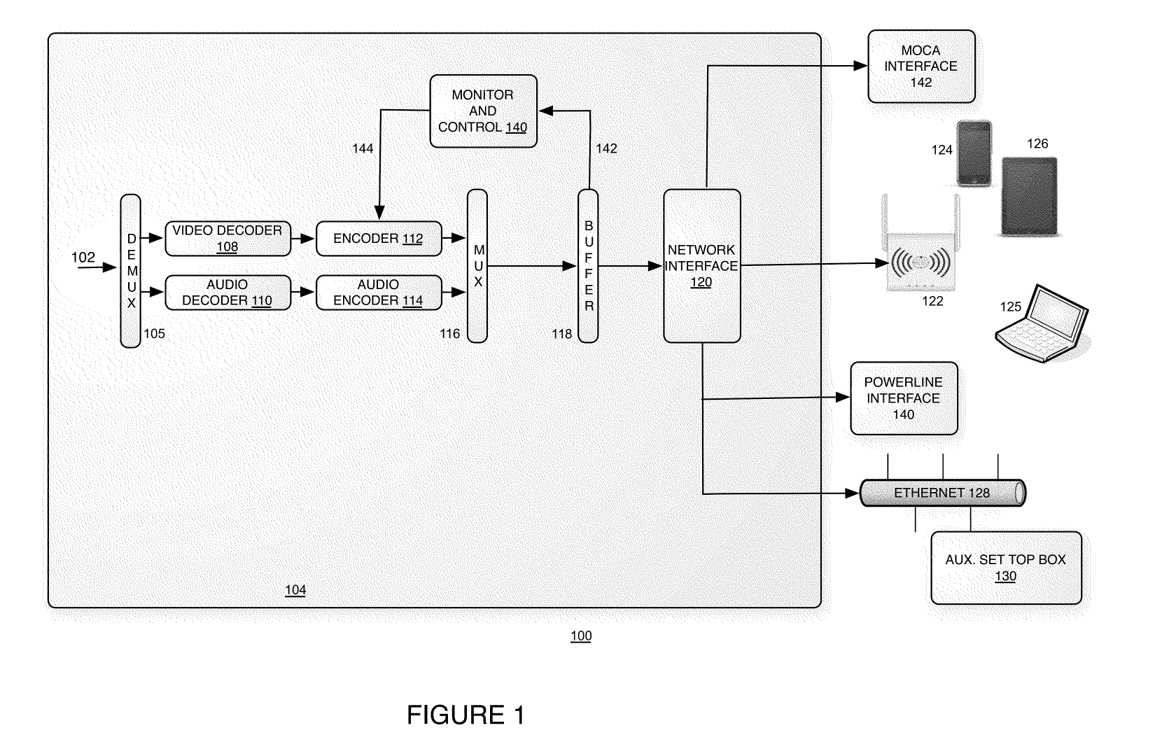

FIG. 1 is a schematic diagram of a streaming arrangement including a video encoder having a controllable encoding rate according to an embodiment of the invention. This embodiment illustrates a runtime configurable bit rate media server 104. Media server 104 may be, for example, a fully functional set top box including a hard drive (such as in a DVR for recording television broadcasting), etc. which receives an input stream 102 from a cable system, a satellite system, etc. Media server 104 streams media (a video and audio data stream) from input stream 102 via a network interface 120 to various portable devices, such as for example, a PDA 124, a computer 125 and a tablet 126, all via a WiFi router 122. Media is also streamed from network interface 120 via an Ethernet network 128 to a set an auxiliary set top box 130. Auxiliary set top box 130 may be a fully functional set top box media server such as media server 104 or it may be a less function, more bare bones set top box, such as for example, without a hard drive and without the full functionality of a “main” set top box in the home. Media may also be streamed from network interface 120 to power line interface 140 for distribution over a power line, such as, for example power line carrier (PLC), power line telecom (PLT), power line networking (PLN) and broadband over power line (BPL). Media may also be streamed from network interface 120 to a MoCa interface 142 for distribution over a coaxial cable.

Input data stream 102 may originate from any source including but not limited to a satellite signal, digital subscriber line (DSL), a local hardware source, etc. Input data stream 102 is coupled to a demultiplexer 105 where the data is split into video and audio data streams. The video data stream is coupled to a video decoder 108 and the audio data stream is coupled to an audio decoder 110. An output of video decoder 108 is coupled to an encoder 112 that can be operated at a variable encoding rate. An output of audio decoder 110 is coupled to an audio encoder 114. Outputs of encoders 112 and 114 are multiplexed by a multiplexer 116, the output of which is coupled to a buffer 118. Buffered output from buffer 118 is coupled to an input of network interface 120 for transmission to client devices. Although the embodiments show an encoder and decoder, the invention is also applicable to signals not requiring a decoder, e.g. HDMI input directly to the encoder. All of the elements inside of media server 104 (demux, decoders, encoders, mux, buffer, and network interface) can be implemented as part of a SoC integrated circuit, such as a BCM7425 integrated circuit manufactured by Broadcom Corporation. Buffer 118 can be implemented as part of a DRAM or other memory device. The functions of monitor and control 140 can be implemented a software running on a processor, such as, for example, the processor of a BCM7425 integrated circuit manufactured by Broadcom Corporation. This particular integrated circuit is named as an example. There are other suitable integrated circuits and configurations that are effective in accordance with the principles of the invention.

Buffer 118 temporarily stores data from multiplexer 118 and feeds that data to network interface 120 for streaming to various devices. The available link bit rate from network interface 120 to devices, such as PDA 124, computer 125, tablet 126, auxiliary set top box 130, etc. can be variable due to a variety of conditions. It is difficult to predict a guaranteed bandwidth to the ultimate receiving client such as, for example, tablet 126 or mobile device 124. For example, the WiFi router 122 may not be able to provide a strong signal to a mobile device 124 that has been moved out to a deck of the house and is separated from it by a metal-framed wall. Under such circumstances, the portable device would not be able to accept and process a data stream encoded at a higher rate than it is able to receive. On the other hand, if data is encoded by encoder 112 at a very slow rate to accommodate all possible link conditions downstream, a portable device cannot take advantage of the potentially higher quality available from a higher encoding rate because that rate is not used.

According to the invention, in order to stream at the potentially best available quality, the coding rate of encoder 112 is adapted to various link conditions. When conditions are poor (available link rate is low), encoder 112 is caused to encode at a slower rate. A portable device than then keep up with the data stream created by encoder 112. On the other hand, when the available link rate is high, such as when there is a strong WiFi signal with a good signal to noise ratio, the encoding rate of encoder 112 is increased so that a better quality media stream can be sent to a portable device.

A monitor and control module 140 is provided to determine the depth of buffer 118 and provide feedback to encoder 112 to change its bit rate of encoding. Determining the depth of buffer 118 is represented functionally by arrow 142. Control of encoding rate of encoder 112 is functionally represented by arrow 144. The depth of buffer 118 is, in effect, a measure of available link rate. As link rate decreases, buffer 118 will fill because network interface 120 cannot stream to a portable device fast enough to keep up with encoded data being received by the buffer. On the other hand, as link rate increases, buffer 118 will empty because network interface 120 is able to stream to a portable device at a fast enough rate to empty it.

Monitor and control module 140 can operate in various ways and manners.

One such manner is described in this FIG. 1 embodiment. Monitor and control module 140 monitors the depth of buffer 118 as an indicator of link speed. Data from multiplexer 116 is written to a ring buffer in DRAM (not shown). This data is read by network interface 120 as fast as available link speed allows. By looking at ring buffer read/write pointers periodically (period can be 10 msec. to 10 s, depending on implementation) buffer depth is monitored. If the encoding rate of encoder 112 is exactly compatible with link speed, the buffer size will be constant.

If the buffer size is reducing, monitor and control module 140 interprets that reduction as an increasing link rate. In response, monitor and control module 140 increases the encoding rate of encoder 112. This causes a better quality data stream to be provided. A portable device receiving the data stream will see a graceful increase of stream quality, taking advantage of the available link rate.

If the depth of buffer 118 is increasing, monitor and control module 140 interprets the increased buffer depth as a reduction in link rate. It then causes the encoding rate of encoder 112 to decrease in order gracefully reduce data rate quality in accordance with available link rate. To avoid often changes of encoder bit rate, generally thresholds are added to buffer depth monitors. There are other ways to monitor link bit rate.

The following is an explanatory example. Assume that an encoder nominally operates at 10 Mbps. For some reason, a supported link rate drops to 5 Mbps. The buffer upstream from the networking interface will start filling. A growing buffer size indicates a reduction in link speed. The encoder, in response is adjusted to encode at a bit rate to 5 Mbps or lower than 5 Mbps. If, thereafter, the link speed improves to e.g. 12 Mbps, the buffer starts to empty and the encoder can increase bit rate for better quality. In this manner, it is possible to provide the best available audio/video quality when the link supports higher bit rates and gracefully downgrade quality as link speed reduces.

Control of encoding bit rate is transparent to client, and does not need to define new protocol to indicate speed change. In essence, the media server is self-learning about it. This scheme thus does not incur additional protocol related overhead in either server or client.

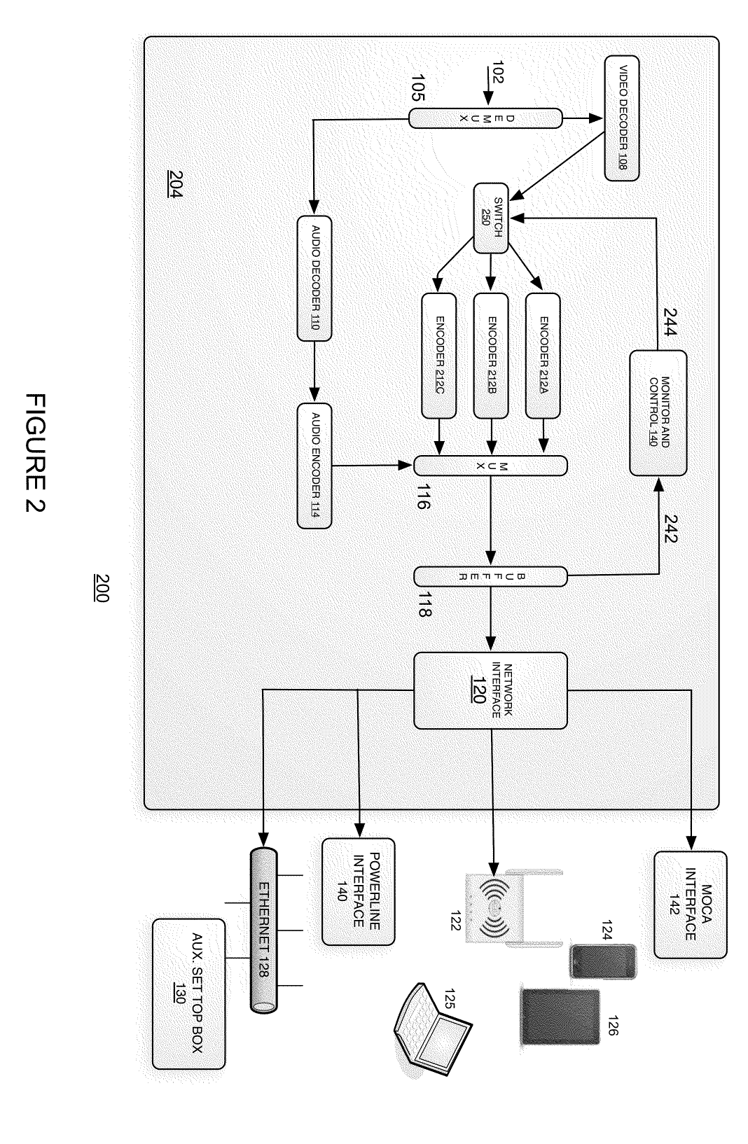

FIG. 2 is a schematic diagram of a streaming arrangement including a media server 204 according to an embodiment of the invention. In this embodiment, a single variable rate encoder, such as, for example, encoder 112 shown in FIG. 1, is replaced by plural encoders 212 (including 212A, 212B and 212C) having different encoding rates that are switch selectable by a switch 250. Encoders 212A, 212B and 212C, each operate at a different encoding rate. A switch 250 directs the output of video decoder 108 to one of the encoders 212 based upon a desired encoding bit rate. Thus, instead of changing the encoding bit rate of a single encoder (such as in the FIG. 1 embodiment), a particular one of encoders 212A, 212B and 212C is selected that has the desired encoding bit rate in order to be compatible with available link rate. Determining the depth of buffer 118 is represented functionally by arrow 242. Control of switch 250 to select a particular one of encoders 212 is functionally represented by arrow 244. In all other aspects, the FIG. 2 embodiment is the same as the FIG. 1 embodiment.

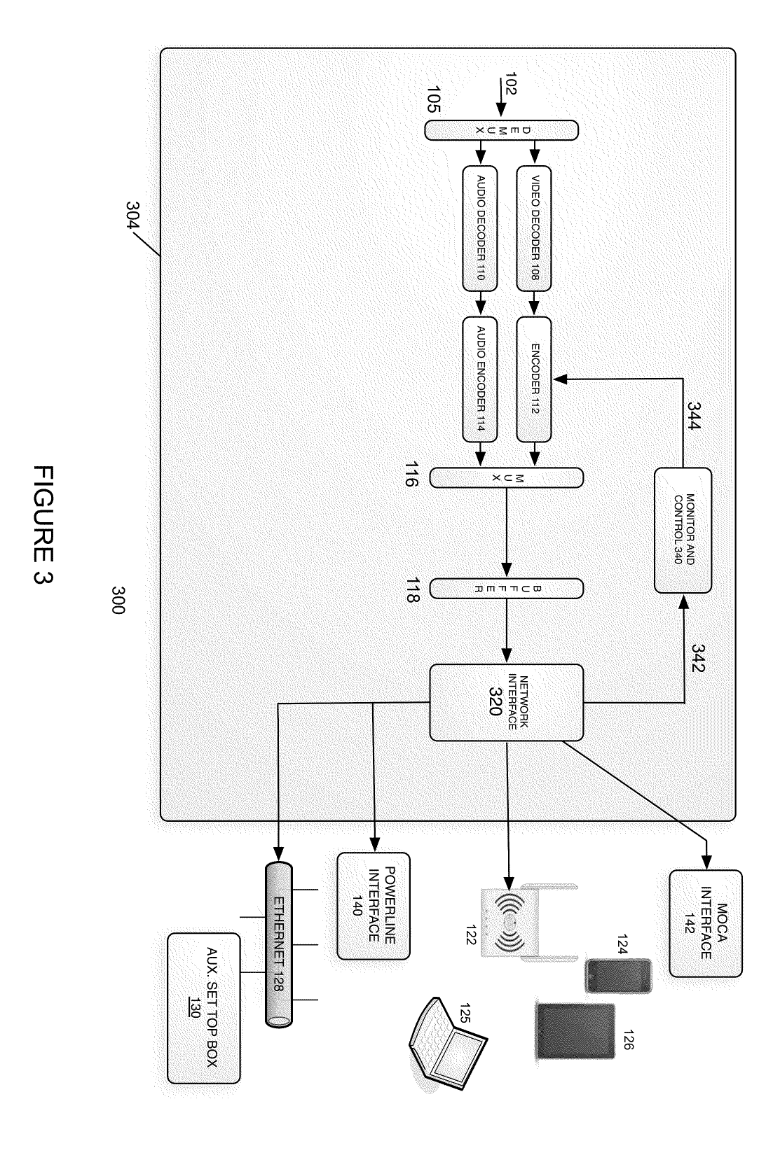

FIG. 3 is a schematic diagram of a streaming arrangement including a media server 304 according to an embodiment of the invention in which the encoding rate of an encoder 112 is determined based on a link rate of streaming data. In this embodiment, encoder 112 is a variable rate encoder, such as in the FIG. 1 embodiment. However, instead of the link rate being determined based on the depth of buffer 118, the link rate is measured at network interface 320. Determining the link rate by a control and monitoring module 340 is represented functionally by arrow 342. Control is functionally represented by arrow 344. Network interface can provide a measure of link rate in a number of known ways and manners. There are hardware and software modules that, for example, provide an indication of WiFi link rate.

In managed networks, every audio/video flow can be allocated a bit rate depending on number of active connections. When the number of network-connected devices is changed the bit rate is negotiated by devices on the network. For example, if only one client is connected, the server can feed 20 Mbps, and if second client is added, the bit rate can be reduced for each client to 10 Mbps. i.e. instead of checking actual buffer depth, network manager can decide/change bit rate allocated to each device.

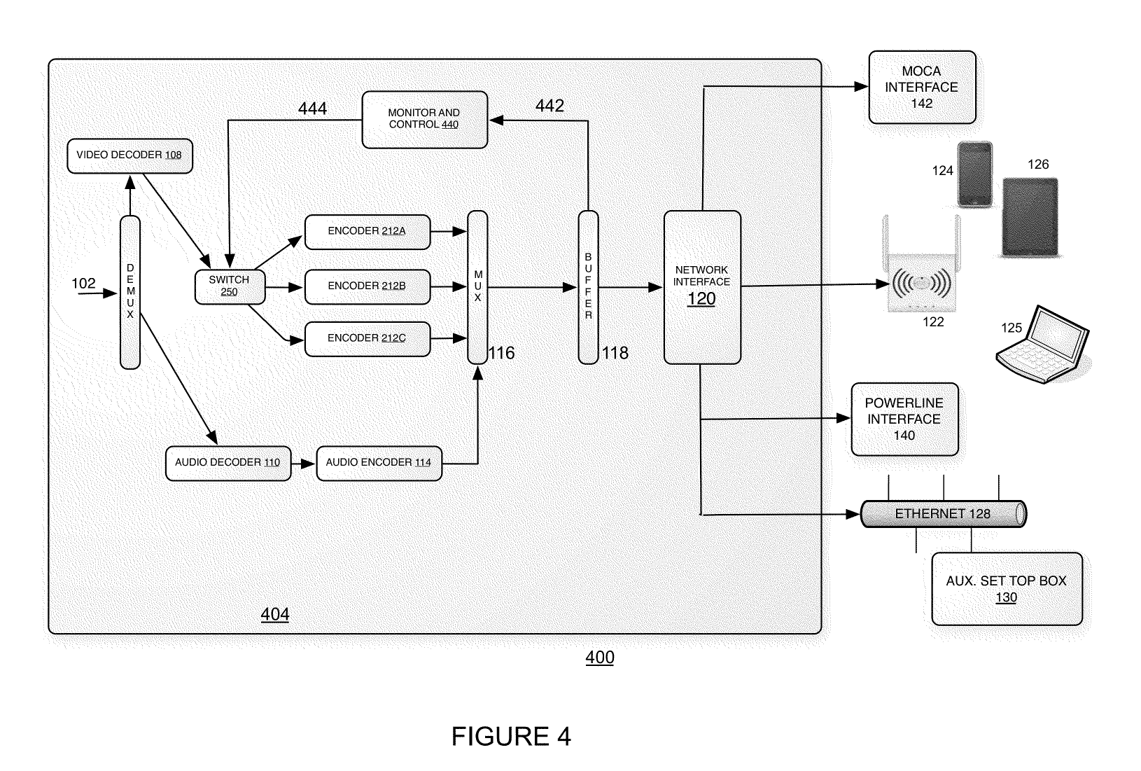

FIG. 4 is a schematic diagram of a streaming arrangement including a media server 404 according to an embodiment of the invention in which the encoding rate of an encoder is determined based on a link rate of streaming data. In this embodiment, the link rate is determined in a manner similar to the manner in which it is determined in the FIG. 3 embodiment. Determining the link rate is represented functionally by arrow 442. Control switch 250 to select a particular encoder 212 is functionally represented by arrow 444. In this FIG. 4 embodiment, instead of controlling the encoding bit rate of a single encoder (as in the FIG. 1 embodiment), one of plural encoders 212 is switch selected as in the FIG. 2 embodiment.

### CONCLUSION

It is to be appreciated that the Detailed Description portion of this patent document, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

Various embodiments of the present invention have been described above. It should be understood that they have been presented by way of example only, and not limitation. It will be apparent to persons skilled in the relevant art that various changes in form and detail can be made from those specifically described without departing from the spirit and scope of the invention. Thus, the breadth and scope of the present invention should not be limited by any of the above-described exemplary embodiments, but should be defined only in accordance with the following claims and their equivalents.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. An encoder arrangement for streaming media, comprising:
a variable rate encoder configured and arranged to receive an input data stream and output an encoded data stream;
a buffer arranged to receive the encoded data stream and output a buffered data stream; and
a control means for monitoring a depth of the buffer and controlling the encoding rate of the variable rate encoder.

2. An encoder arrangement according to claim 1 wherein while streaming the encoding rate of the variable rate encoder is changed dynamically depending on link speed at a server and the encoding rate is transparent to a client receiving the streaming media.

3. An encoder arrangement according to claim 1 wherein the rate of encoding can be changed on any frame boundary of the data stream, and no pre-determined points in the data stream are required to change encoding bit rates.

4. An encoder arrangement for streaming media, comprising:
a plurality of encoders, each having a different encoding rate, each configured and arranged to receive an input data stream and output an encoded data stream;
a buffer arranged to receive the encoded data stream from any of the encoders and output a buffered data stream; and
a control means for monitoring a depth of the buffer and controlling which of the plural buffers will actively encode the input data stream and provided an encoded data stream to the buffer.

5. An encoder arrangement according to, claim 4 wherein while streaming the encoding rate of the variable rate encoder is changed dynamically depending on link speed at a server and the encoding rate is transparent to a client receiving the streaming media.

6. An encoder arrangement according to claim 4 wherein the rate of encoding can be changed on any frame boundary of the data stream, and no pre-determined points in the data stream are required to change encoding bit rates.

7. An encoder arrangement for streaming media, comprising:
a variable rate encoder configured and arranged to receive an input data stream and output an encoded data stream;
a buffer arranged to receive the encoded data stream and output a buffered data stream; and
a control means for monitoring a link speed of the streaming media and controlling the encoding rate of the variable rate encoder.

8. An encoder arrangement according to claim 7 wherein the link speed is determined by a client receiving the streaming media.

9. An encoder arrangement according to claim 7 wherein the rate of encoding can be changed on any frame boundary of the data stream, and no pre-determined points in the data stream are required to change encoding bit rates.

10. A media server for, streaming media, comprising:
a variable rate encoding arrangement configured and arranged to receive an input data stream and output an encoded data stream;
a buffer arranged to receive the encoded data stream and output a buffered data stream; and
a control means for determining within the media server an available link rate and control the encoding rate of the variable rate encoding arrangement based on the available link rate.

11. A media server according to claim 10 wherein the variable rate encoding, arrangement comprising a variable rate encoder.

12. A media server according to claim 10 wherein the variable rate encoding arrangement includes a plurality of switch selectable encoders each having a different encoding rate.

13. An encoder arrangement for streaming media, comprising:
a plurality of encoders, each having a different encoding late, each configured and arranged to receive an, input data stream and output an encoded, data stream;
a buffer arranged to receive the encoded data stream from any of the encoders and output a buffered data stream; and
a control means for monitoring a link speed of the streaming media and controlling which of the plural buffers will actively encode the input data stream and provided an encoded data stream to the buffer.

14. An encoder arrangement according to claim 13 wherein the link speed is determined by a client receiving the streaming media.

15. An encoder arrangement according to claim 13 wherein the rate of encoding can be changed on any frame boundary of the data stream, and no pre-determined points in the data stream are required to change encoding bit rates.

16. An encoder arrangement for streaming media, comprising:
a plurality of encoders, each having a different encoding rate, each configured and arranged to receive an input data stream and output an encoded data stream, thereby producing plural data streams, each having a different encoding rate; and
a control means for monitoring a link speed depth of the buffer and selecting an encoded data stream based on the link speed.

17. An encoder arrangement according to claim 16 wherein the rate of encoding can be changed on any frame boundary of the data stream, and no pre-determined points in the data stream are required to change encoding bit rates.

18. An encoder arrangement for streaming media, comprising:
an encoder arrangement configured and arranged to have a variable rate of encoding and further arranged to receive an input data stream and output an encoded data stream; and
a control means for controlling the rate of encoding dynamically depending on link speed at a server providing the input data stream, the encoding rate being transparent to a client receiving the encoded data stream.

19. An encoder arrangement according to claim 18 wherein the rate of encoding can be changed on any frame boundary of the data stream, and no pre-determined points in the data stream are required to change encoding bit rates.
